(19) United States
(12) Patent Application Publication
(10) Pub. No.: US 2011/0039017 A1
(43) Pub. Date: Feb. 17, 2011

(54) METHOD FOR MANUFACTURING THIN FILM

(76) Inventors: Sadayuki Okazaki, Osaka (JP); Kazuyoshi Honda, Osaka (JP)

Correspondence Address: MCDERMOTT WILL & EMERY LLP, 600 13TH STREET, NW, WASHINGTON, DC, 20005-3096, US

(21) Appl. No.: 12/989,628

(22) PCT Filed: May 21, 2009
(86) PCT No.: PCT/JP2009/002244

§ 371 Date: Oct. 25, 2010

(30) Foreign Application Priority Data
May 21, 2008 (JP) 2008-133421

(51) Int. Cl. H01M 4/04

(52) U.S. Cl. 427/8

(57) ABSTRACT

The present invention provides a thin film manufacturing method for improving a production volume by predicting expansion of a hole defect or a crack on a substrate and preventing the substrate from tearing. The thin film manufacturing method includes the steps of: depositing a deposition material on a surface of the substrate in a deposition region to form a thin film while carrying out take-up travel of the substrate between a first roll and a second roll; irradiating a predetermined portion of the surface of the substrate with an electromagnetic wave or a particle beam at a location in front of the deposition region and/or a location behind the deposition region between the first roll and the second roll and detecting the electromagnetic wave or particle beam, which has been transmitted through the substrate or reflected by the substrate; storing information regarding the detected electromagnetic wave or particle beam and the predetermined portion; determining based on the detected electromagnetic wave or particle beam whether or not a defect of the substrate at the predetermined portion is increasing; and carrying out an operation of preventing the substrate from tearing, in accordance with a determination result of the determining step.

### TECHNICAL FIELD

The present invention relates to a method for manufacturing a thin film, and particularly to a method for manufacturing a thin film utilized as an electrode for a nonaqueous electrolyte secondary battery.

### BACKGROUND ART

As mobile devices increase in performance and functionality in recent years, secondary batteries used as power supplies of these mobile devices need to be increased in capacity. In order to increase the capacity of the secondary battery, a lithium secondary battery electrode using a negative-electrode active material, such as silicon (Si), germanium (Ge), or tin (Sn), has been actively studied.

In the lithium secondary battery electrode using silicon, since the electrode active material vigorously expands and shrinks by the repetition of charge and discharge, it is crushed or miniaturized. Therefore, the surface area increases, the decomposition reaction of the electrolytic solution is accelerated, and the power-collecting property deteriorates. Here, an electrode in which an electrode active material layer is formed on a current collector using a film forming method utilizing deposition, such as a deposition method, a sputtering method, or a CVD method, has been studied. As compared to a coat-type electrode to which a slurry containing the electrode active material, a binder, and the like is applied, the electrode formed by the film forming method utilizing the deposition can obtain high film strength. Therefore, the miniaturization of the electrode active material at the time of charge and discharge can be suppressed. Moreover, since the current collector and the electrode active material layer can be integrated with each other, the electron conductivity of the electrode can be improved. As a result, the electrode formed by using the film forming method utilizing the deposition can be expected to have a larger capacity and a longer cycle life than the conventional coat-type electrode.

A method for increasing the capacity of the electrode by utilizing the features of the film forming method utilizing the deposition capable of reducing or removing the electrically conductive material, the binder, and the like has been studied (see PTL 1, for example).

In accordance with the electrode formed by the film forming method utilizing the deposition, the strength of the electrode active material layer can be improved. However, the problems are that by the expansion and shrink of the electrode active material due to charge and discharge, for example, the current collector and the electrode active material layer are easily separated from each other, and wrinkles are easily generated on the current collector. Here, a deposition apparatus has been proposed, which obliquely deposits the electrode active material on a substrate having a concave-convex pattern in a state where an angle formed between a normal line of the substrate and a normal line of a melting surface of a deposition material of an evaporation source is set to be oblique (see PTL 2, for example).

In a case where an elongated film is subjected to some kind of processing, the problem is that a defect on the film causes processing troubles in the process, and this deteriorates a product yield. Here, disclosed is a method for detecting the defect on the film during the processing and changing manufacturing conditions depending on the defect (see PTL 3, for example).

### Citation List

### Patent Literature

PTL 1: Japanese Laid-Open Patent Application Publication No. 11-135115

PTL 2: International Publication No. 2007/15419A1

PTL 3: Japanese Patent No. 3400305

### SUMMARY OF INVENTION

### Technical Problem

In the case of carrying out the deposition with respect to a film substrate, the problems are the defect which is originally open on the film substrate, and in addition, the defect that is a hole made on the substrate such that a material mass generated by bumping of the deposition materials hits the substrate. Especially in the case of forming a deposited film on an elongated film substrate while causing the elongated film substrate to travel, the problem is that even if the hole formed on the substrate is a small pinhole-like hole, the substrate cracks by the hole as a trigger and tears while traveling. Further, in the case of carrying out the deposition while repeatedly reversing the travel direction of the substrate, a possibility that the hole on the substrate expands and the substrate cracks and tears when a tension applied to the substrate changes, such as when the travel direction is reversed, increases. In a case where the substrate tears during the manufacture of the deposited film, the product yield deteriorates, and contamination in the manufacturing apparatus expands. Since it takes time to restore the device, the production volume decreases.

An object of the present invention is to provide a thin film manufacturing method for increasing the production volume by predicting the expansion of hole defects and cracks on the substrate and preventing the substrate from tearing.

### Solution to Problem

In order to solve the above problems, a method for manufacturing a thin film according to the present invention includes: a first film forming step of depositing a deposition material on a surface of a substrate in a deposition region to form the thin film while carrying out take-up travel of the substrate between a first roll and a second roll; a first detecting step of irradiating a predetermined portion of the surface of the substrate with an electromagnetic wave or a particle beam at a location in front of the deposition region and/or a location behind the deposition region on a travel passage of the substrate between the first roll and the second roll and detecting the electromagnetic wave or particle beam, which has been transmitted through the substrate or reflected by the substrate; a storing step of storing information regarding the electromagnetic wave or particle beam detected in the first detecting step and the predetermined portion; a determining step of determining based on the electromagnetic wave or particle beam detected in the first detecting step whether or not a defect of the substrate at the predetermined portion is increasing; and a preventing step of carrying out an operation of preventing the substrate from tearing, in accordance with a determination result of the determining step.

Preferably, in the first detecting step, irradiation of the electromagnetic wave or particle beam is carried out at a plurality of locations on the travel passage of the substrate between the first roll and the second roll to irradiate the predetermined portion with the electromagnetic wave or the particle beam plural times, and a plurality of electromagnetic waves or particle beams which have been transmitted through the substrate or reflected by the substrate are detected, and in the determining step, whether or not the defect of the substrate at the predetermined portion is increasing is determined by comparing the plurality of detected electromagnetic waves or particle beams with one another.

Preferably, the plurality of locations includes the location in front of the deposition region and the location behind the deposition region, and in the determining step, whether or not the defect of the substrate at the predetermined portion is increasing is determined by comparing the electromagnetic wave or particle beam detected at the location in front of the deposition region with the electromagnetic wave or particle beam detected at the location behind the deposition region.

Preferably, the method further includes: a reversing step of reversing a travel direction of the substrate after the first film forming step; a second film forming step of further forming, after the reversing step, a thin film on the thin film formed in the first film forming step while carrying out the take-up travel of the substrate in a direction opposite to a take-up direction of the first film forming step; and a second detecting step of irradiating, after the reversing step, the predetermined portion with the electromagnetic wave or the particle beam again at the location in front of the deposition region and/or the location behind the deposition region on the travel passage of the substrate between the first roll and the second roll and detecting the electromagnetic wave or particle beam which has been transmitted through the substrate or reflected by the substrate, wherein in the determining step, whether or not the defect of the substrate at the predetermined portion is increasing is determined by comparing the electromagnetic wave or particle beam detected in the first detecting step with the electromagnetic wave or particle beam detected in the second detecting step.

Preferably, the irradiation of the electromagnetic wave or particle beam is carried out with respect to a plurality of regions arranged in a width direction of the substrate.

Preferably, the defect is a hole or a crack on the substrate.

Preferably, each of the irradiating electromagnetic wave and the irradiating particle beam is ultraviolet, visible light, infrared light, X-ray, or β-ray.

Preferably, each of the detected electromagnetic wave and the detected particle beam is the ultraviolet, the visible light, the infrared light, fluorescence X-ray, or scattered β-ray.

Preferably, the irradiating electromagnetic wave is the ultraviolet, the visible light, or the infrared light, and the detected electromagnetic wave is the ultraviolet, visible light, or infrared light, which has been transmitted through the substrate.

Preferably, each of the irradiating electromagnetic wave and the irradiating particle beam is the X-ray or the β-ray, and each of the detected electromagnetic wave and the detected particle beam is the fluorescence X-ray or scattered β-ray, which has been reflected by the substrate.

Preferably, each of the irradiating electromagnetic wave and the irradiating particle beam is the X-ray or the β-ray, and each of the detected electromagnetic wave and the detected particle beam is the fluorescence X-ray or scattered β-ray, which has been reflected by a roll supporting the substrate or by a metal plate provided behind the substrate.

Preferably, the operation of preventing the substrate from tearing is cancellation of film formation, a reduction in amount of the film formation, a change in travel speed of the substrate, or a reduction in tension applied to the substrate between the first roll and the second roll.

### ADVANTAGEOUS EFFECTS OF INVENTION

In accordance with the thin film manufacturing method of the present invention, the product yield and the production volume can be increased by predicting the expansion of hole defects and cracks during the formation of the deposited film and preventing the substrate from tearing before the tearing of the substrate occurs.

### BRIEF DESCRIPTION OF DRAWINGS

FIG. 1 is a schematic cross-sectional view of a thin film manufacturing apparatus of Embodiment 1 of the present invention.

FIG. 2 is another schematic cross-sectional view of the thin film manufacturing apparatus of Embodiment 1 of the present invention.

FIG. 3 is a schematic cross-sectional view of the thin film manufacturing apparatus of Embodiment 2 of the present invention.

FIG. 4 is another schematic cross-sectional view of the thin film manufacturing apparatus of Embodiment 2 of the present invention.

FIG. 5 is a diagram for explaining the configuration of a dose detecting portion of the embodiment of the present invention.

FIG. 6(a) is an operation flow chart of Embodiment 1 of the present invention.

FIG. 6(b) is a determination chart of Embodiment 1 of the present invention.

FIG. 7(a) is an operation flow chart of Embodiment 2 of the present invention.

FIG. 7(b) is a determination chart of Embodiment 2 of the present invention.

FIG. 8(a) is a schematic diagram of the configurations of a source portion and dose detecting portion of the embodiment of the present invention.

FIG. 8(b) is a schematic cross-sectional view of other configurations of the source portion and dose detecting portion of the embodiment of the present invention.

FIG. 9(a) is a diagram for explaining a relation between a measurement time and a measurement dose intensity of the embodiment of the present invention.

FIG. 9(b) is a diagram for explaining a relation between a sampling time and the measurement dose intensity of the embodiment of the present invention.

FIG. 10(a) is a diagram for explaining the measurement time and a measured value movement of the embodiment of the present invention.

FIG. 10(b) is a diagram for explaining the measurement time and the movement of the number of measurement sensors of the embodiment of the present invention.

### DESCRIPTION OF EMBODIMENTS

Hereinafter, embodiments of a thin film manufacturing method according to the present invention will be explained in reference to the drawings.

### Embodiment 1

The present embodiment will explain one example of a thin film manufacturing apparatus in which in a chamber, a sheet-shaped substrate is conveyed so as to be convex with respect to an evaporation source, and the deposition is carried out on each of regions located on both sides of a portion that is a top of the convex.

### Configuration of Thin Film Manufacturing Apparatus

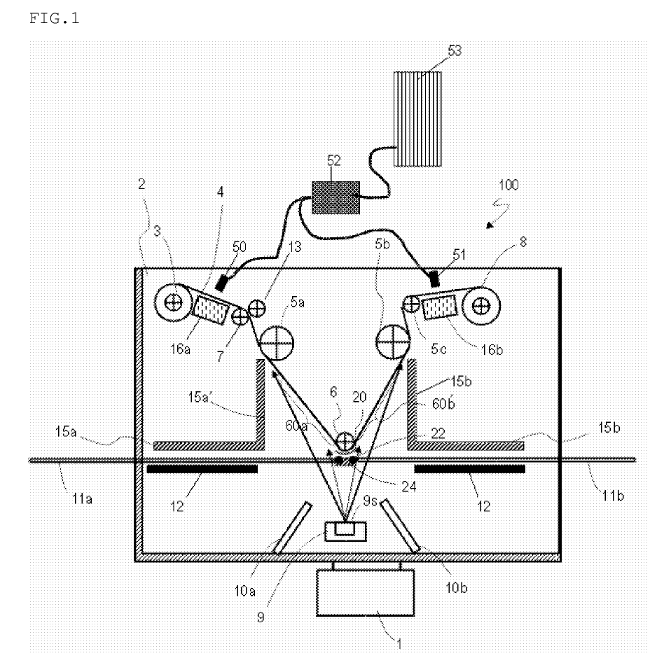

First referred is FIG. 1. FIG. 1 is a cross-sectional view schematically showing a thin film manufacturing apparatus of Embodiment 1 of the present invention. A thin film manufacturing apparatus 100 includes: a chamber (vacuum chamber) 2; an exhaust pump 1 provided outside the chamber 2 to discharge a gas from the chamber 2; and gas introduction tubes 11a and 11b through which gases, such as an oxygen gas, are introduced from the outside of the chamber 2 to the chamber 2. In addition, a data storage processing device 53 is provided, to which a driving device (not shown) configured to drive a shutter 12, a driving device (not shown) configured to drive first and second rolls 3 and 8, and a length measuring system 13 in the chamber are connected. Provided inside the chamber 2 are an evaporation source 9 configured to evaporate a deposition material, a conveying portion configured to convey a sheet-shaped substrate 4, a shielding portion and shutter portion configured to form a shielded region to which the deposition material evaporated by the evaporation source 9 does not reach, and a nozzle portion 22 connected to the gas introduction tubes 11a and 11b to supply the gas to the surface of the substrate 4.

As an inspection device configured to measure the defect (pinholes and substrate cracks) of the substrate 4 and determine whether to execute the deposition and cause the substrate to travel, source portions 16a and 16b, dose detecting portions 50 and 51, a controller 52 configured to control the dose detecting portions, and the data storage processing device 53 are provided. Moreover, in order to inspect the entire region of the substrate 4 in a width direction of the substrate 4, each of the dose detecting portions 50 and 51 includes a plurality of sensors arranged along the width direction. Here, used as the source portions 16a and 16b are light sources, such as fluorescent lights, deuterium lamps, halogen lamps, and xenon arc lamps, β-ray sources, such as Pm-147, Co-60, Cs-137, T1-204, Sr-90, Y-90, and Ca-45, and X-ray sources. It is especially effective to select the shielded source depending on a substrate material and a substrate thickness. Moreover, in the case of detecting light beams, instead of arranging a plurality of sensors, each of the dose detecting portions 50 and 51 may be a sensor, such as a line sensor or a CCD camera, which has a wide light measurement area and can carry out highly sensitive detection. In the case of detecting scattered β-ray or fluorescence X-ray, each of the dose detecting portions 50 and 51 may be a semiconductor detector or the like since it is used in vacuum.

The evaporation source 9 includes a container, such as a crucible configured to store, for example, the deposition material and a heater configured to evaporate the deposition material. The evaporation source 9 is configured such that the deposition material and the container are suitably detachable. Examples of the heater are a resistance heater, an induction heater, and an electron beam heater. When carrying out the deposition, the deposition material stored in the crucible is heated by the heater to evaporate from an upper surface (evaporation source) 9s thereof. Thus, the deposition material is supplied to the surface of the substrate 4 by open and close of the shutter 12. The shutter 12 constituting the above-described shutter portion is connected to a driving device (not shown) disposed outside the chamber and can open and close by the data storage processing device 53 or an open-close button of the shutter 12.

The conveying portion includes: first and second rolls 3 and 8 each configured to take up and hold the substrate 4; a guiding portion configured to guide the substrate 4; a driving roller 7 configured to adjust a conveyance direction; and the length measuring system 13. The length measuring system 13 measures a conveyance distance and conveyance speed of the substrate 4 to adjust a conveyance length and the conveyance speed. The guiding portion includes a first guide member (herein, a feed roller) 6 and the other feed rollers 5a to 5c. With this, a conveyance passage of the substrate 4 is defined such that the substrate 4 passes through a region (deposition possible region) to which the deposition material evaporated from the evaporation surface 9s reaches.

The first and second rolls 3 and 8 are connected to a driving device (not shown) disposed outside the chamber and can take up and pull out the substrate 4. Moreover, the driving roller 7 is connected to a driving device (not shown) disposed outside the chamber and can control the conveyance direction and conveyance speed of the substrate 4.

Moreover, each of the first and second rolls 3 and 8, the feed rollers 5a to 5c, the driving roller 7, and the first guide member 6 has, for example, a cylindrical shape having a length of 600 mm. The first and second rolls 3 and 8, the feed rollers 5a to 5c, the driving roller 7, and the first guide member 6 are arranged in the chamber such that length directions (that is, the width direction of the substrate 4 conveyed) thereof are parallel to one another. FIG. 1 shows only a cross section parallel to the bottom surface of each cylindrical shape.

The evaporation source 9 may be configured such that, for example, the evaporation surface 9s of the deposition material has an adequate length (600 mm or more, for example) in a direction parallel to the width direction of the substrate 4 conveyed by the conveying portion. With this, the deposition can be carried out substantially uniformly in the width direction of the substrate 4. The evaporation source 9 may be configured to include a plurality of crucibles arranged along the width direction of the substrate 4 conveyed.

In the present embodiment, one of the first and second rolls 3 and 8 unrolls the substrate 4, the driving roller 7, the feed rollers 5a to 5c, and the first guide member 6 guide the unrolled substrate 4 along the conveyance passage, and the other one of the first and second rolls 3 and 8 takes up the substrate 4. The taken-up substrate 4 is again unrolled by the other roll according to need and is conveyed in the opposite direction along the conveyance passage. Each of the first roll 3 and the second roll 8 drives to take up the substrate 4. Thus, the substrate is pulled and balanced. Here, by driving the driving roller 7, the substrate 4 can move along the driving roller 7 to be taken up by one of the first and second rolls 3 and 8. For example, in a case where the driving roller 7 rotates in a clockwise direction in FIG. 1, the substrate 4 is conveyed to be taken up by the second roll 8. The conveyance speed and the conveyance distance are suitably adjusted by the length measuring system 13. As above, each of the first and second rolls 3 and 8 in the present embodiment can serve as a pull-out roll and a take-up roll depending on the conveyance direction. Moreover, since the number of times the substrate 4 passes through the deposition region can be adjusted by repeatedly reversing the conveyance direction, the deposition step can be continuously carried out a desired number of times.

The driving roller 7, the feed roller 5a, the first guide member 6, and the feed rollers 5b and 5c are arranged in this order from a first roll side on the conveyance passage of the substrate 4. In the present description, the “first roll side on the conveyance passage of the substrate 4” denotes the first roll side on the conveyance passage having both ends on which the first and second rolls 3 and 8 are respectively disposed, regardless of the conveyance direction of the substrate 4 and the spatial arrangement of the first roll. Moreover, the feed roller 6 is provided lower than the adjacent feed rollers 5a and 5b. The feed roller 6 guides the substrate 4 such that a surface of the substrate 4 which surface is exposed to the deposition material is convex with respect to the evaporation source 9. Here, “guiding the substrate 4 such that the substrate 4 is convex with respect to the evaporation source 9” denotes guiding the substrate 4 such that the substrate 4 is convex with respect to the evaporation surface 9s. With this configuration, in the cross-sectional view, the passage of the substrate 4 has a V shape or a U shape such that the substrate 4 turns around at the feed roller 6. In the present description, the V-shaped or U-shaped passage defined by the first guide member 6 is called a “V-shaped passage”.

A first shielding member 20 is provided between the first guide member 6 and the evaporation source 9 (evaporation surface 9s). With this, the deposition material evaporated from the evaporation surface 9s is prevented from being incident from the normal direction of the substrate 4, and the deposition region of the V-shaped passage is divided into two regions. With this configuration, a first deposition region 60a and a second deposition region 60b are formed. The first deposition region 60a is located on the first roll side of the first guide member 6 on the conveyance passage of the substrate 4, and the second deposition region 60b is located on a second roll side of the first guide member 6 on the conveyance passage of the substrate 4. In the present description, the names of the deposition regions do not relate to the positions of the first and second rolls 3 and 8 in the chamber 2 and the conveyance direction of the substrate 4. On the V-shaped passage defined by the first guide member 6, a region located on the first roll side of the first guide member 6 is referred to as “the first deposition region 60a”, and a region located on the second roll side of the first guide member 6 is referred to as “the second deposition region 60b”. Therefore, “the first deposition region 60a” may be located on the first roll side of the first guide member 6 on the conveyance passage of the substrate 4. For example, a straight-line distance between the first roll 3 and the first deposition region 60a may be longer than a straight-line distance between the first roll 3 and the first guide member 6.

The shielding portion is provided in the deposition possible region. In addition to the above-described first shielding member 20, the shielding portion includes: shielding plates 10a and 10b provided to cover the evaporation source 9 and an exhaust port (not shown) connected to the exhaust pump 1; a nozzle portion shielding plate 24 provided to cover the nozzle portion 22; and shielding plates 15a and 15b each extending from a side wall of the chamber 2 toward an upper end portion of the first deposition region 60a or an upper end portion of the second deposition region 60b. The shielding plates 15a and 15b are provided to cover the substrate 4 traveling the deposition possible region other than the deposition regions 60a and 60b on the conveyance passage of the substrate 4, the first and second rolls 3 and 8, the source portions 16a and 16b, the dose detecting portions 50 and 51, and the like. Thus, the shielding plates 15a and 15b prevent the deposition material from reaching the deposition possible region other than the deposition regions 60a and 60b, the first and second rolls 3 and 8, the source portions 16a and 16b, the dose detecting portions 50 and 51, and the like. Moreover, the shielding plate 15a includes a wall portion 15a′ facing the deposition region 60a, and the shielding plate 15b includes a wall portion 15b′ facing the deposition region 60b. By these wall portions, the gas emitted from a plurality of emission ports provided on a side surface of the nozzle portion 22 can be effectively retained in the deposition regions 60a and 60b.

The conveying portion and the shielding portion in the present embodiment are provided with respect to the evaporation source 9 such that the deposition material evaporated from the evaporation surface 9s is not incident on the substrate 4 from the normal direction of the substrate 4, the substrate 4 being traveling along the conveyance passage. With this, the deposition (oblique deposition) can be carried out from a direction inclined with respect to the normal direction of the substrate 4. In the thin film manufacturing apparatus 100 shown in FIG. 1, by the first shielding member 20 and the nozzle portion shielding plate 24, the deposition material is prevented from being incident on the substrate 4 from the normal direction of the substrate 4. However, depending on the configuration of the conveying portion, the other shielding plate (15a and 15b, for example) may perform in the same manner as above.

The nozzle portion 22 of the present embodiment is provided between the first shielding member 20 and the nozzle portion shielding plate 24. The nozzle portion 22 is, for example, a tube extending along the width direction (direction perpendicular to the cross section shown in FIG. 1) of the substrate 4 conveyed. A plurality of emission ports configured to eject the gas to the corresponding deposition regions 60a and 60b may be provided on the side surface of the nozzle portion 22. With this, in the first and second deposition regions 60a and 60b, the gas can be supplied substantially uniformly in the width direction of the substrate 4. Moreover, it is preferable that the nozzle portion 22 be configured to eject the gas parallel to each of the first and second deposition regions 60a and 60b. With this configuration, a reaction rate between the oxygen gas ejected from the nozzle portion 22 and deposition particles can be increased, and the deposited film having high degree of oxidation can be formed without decreasing vacuum pressure in the chamber 2.

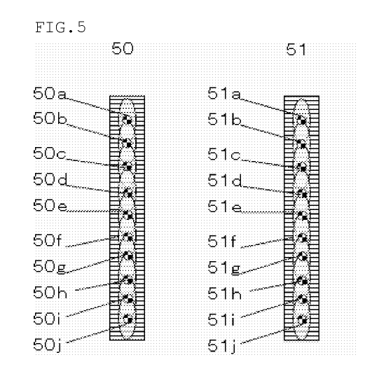

The source portion 16a and the dose detecting portion 50 are provided on the first roll 3 side of the V-shaped passage, and the source portion 16b and the dose detecting portion 51 are provided on the second roll 8 side of the V-shaped passage. Moreover, each of the dose detecting portions 50 and 51 is configured to include a plurality of sensors so as to be capable of performing detection in the entire width direction of the substrate 4 (FIG. 5).

With this configuration, it is possible to determine the increase of the defects of the substrate 4. This will be specifically explained below. The following will explain a case of irradiating the substrate with an electromagnetic wave. However, a particle beam may be used instead of the electromagnetic wave.

Before the substrate 4 having been conveyed from the first roll 3 to the V-shaped passage reaches the deposition region 60a, the electromagnetic wave from the source portion 16a passes through the defect of the substrate to be detected by the dose detecting portion 50. Measured value information of the detected electromagnetic wave is stored in the controller 52 together with positional information of the substrate 4 and is compared with a predetermined set value by the data storage processing device 53.

Next, before the substrate 4 having passed through the deposition region 60a and the deposition region 60b and been subjected to the deposition is taken up by the second roll 8, the electromagnetic wave from the source portion 16b passes through the defect to be detected by the dose detecting portion 51. The measured value information of the detected electromagnetic wave is stored in the controller 52 together with the positional information of the substrate 4 and is compared with a predetermined set value by the data storage processing device 53. Further, the measured value information of the dose detecting portion 50 and the measured value information of the dose detecting portion 51, which have the same positional information as each other, are compared with each other.

Next, the conveyance direction of the substrate 4 is reversed. Before the substrate 4 having been conveyed from the second roll 8 to the V-shaped passage reaches the deposition region 60b, the electromagnetic wave from the source portion 16b passes through the defect to be detected by the dose detecting portion 51. The measured value information of the detected electromagnetic wave is stored in the controller 52 together with the positional information of the substrate 4 and is compared with a predetermined set value by the data storage processing device 53. Further, the measured value information of the dose detecting portion 51 before the substrate conveyance direction is reversed and the measured value information of the dose detecting portion 51 after the substrate conveyance direction is reversed, which have the same positional information as each other, are compared with each other.

Next, before the substrate 4 having passed through the deposition region 60b and the deposition region 60a and been subjected to the deposition is taken up by the first roll 3, the electromagnetic wave from the source portion 16a passes through the defect to be detected by the dose detecting portion 50. The measured value information of the detected electromagnetic wave is stored in the controller 52 together with the positional information of the substrate 4 and is compared with a predetermined set value by the data storage processing device 53. Further, the measured value information of the dose detecting portion 50 and the measured value information of the dose detecting portion 51, which have the same positional information as each other, are compared with each other.

By repeating the same operations, it is possible to determine whether or not the defect on the substrate 4 is equal to or smaller than a set value, whether or not the defect is expanding by the conveyance, or whether or not there is the defect equal to or larger than the set value.

### Operation of Thin Film Manufacturing Apparatus

Next, the operation of the thin film manufacturing apparatus 100 will be explained. The following will explain a case where a plurality of active material bodies containing silicon oxide are formed on the surface of the substrate 4 by using the thin film manufacturing apparatus 100.

First, the elongated (500 meters, for example) substrate 4 winds around one (herein, the first roll 3) of the first and second rolls 3 and 8, the substrate 4 having passed through the conveying portion winds around the other one (herein, the second roll 8) of the first and second rolls 3 and 8, and the substrate 4 is pulled and balanced by a force of 40 N. As the substrate 4, a metal foil, such as a copper foil or a nickel foil, can be used. In order to form a plurality of active material bodies on the surface of the substrate 4 at predetermined intervals, a shadowing effect obtained by the oblique deposition needs to be utilized. Therefore, it is preferable that the concave-convex pattern be formed on the surface of the metal foil. In the present embodiment, used as the concave-convex pattern is, for example, a pattern in which projections are regularly arranged. Each of the projection has a quadrangular prism shape having a rhombic upper surface (diagonal lines: 20 μm×10 μm) and a height of 10 μm. An interval along a longer diagonal line of the rhombic shape is set to 20 μm, an interval along a shorter diagonal line thereof is set to 10 μm, and an interval in a direction parallel to a side of the rhombic shape is set to 10 μm. Moreover, a surface roughness Ra of the upper surface of each projection is set to, for example, 2.0 μm.

Moreover, the deposition material (such as silicon) is stored in the crucible of the evaporation source 9, and each of the gas introduction tubes 11a and 11b is connected to, for example, an oxygen gas bomb provided outside the thin film manufacturing apparatus 100. In this state, the gas is discharged from the chamber 2 using the exhaust pump 1.

Next, in a state where the shutter 12 is closed such that evaporated particles do not reach the surface of the substrate 4, the silicon in the crucible of the evaporation source 9 is heated by a heater (not shown), such as an electron beam heater. After a heating condition is met, the driving roller 7 is activated to unroll the substrate 4 winding around the first roll 3 and start conveying the substrate 4 toward the second roll 8. After the conveyance speed is stabilized (30 seconds, for example), the shutter 12 opens, and the evaporated particles are supplied to the surface of the substrate 4 passing through the first and second deposition regions 60a and 60b. Simultaneously, the oxygen gas is supplied from the nozzle portion 22 through the gas introduction tube 11a and the gas introduction tube 11b to the surface of the substrate 4. With this, a compound (silicon oxide) containing silicon and oxygen can grow on the surface of the substrate 4 by reactive deposition. The substrate 4 having the surface on which the silicon oxide has been deposited in the deposition regions 60a and 60b is taken up by the second roll 8. The length measuring system 13 measures a desired length (400 meters, for example), and the shutter 12 is closed. Then, the taking-up stops, and the substrate conveyance stops.

Next, the substrate conveyance direction can be reversed by reversing the rotational direction of the driving roller 7. When the conveyance speed is stabilized, the shutter 12 opens again, and the evaporated particles are supplied to the surface of the substrate 4 passing through the first and second deposition regions 60a and 60b.

As above, by carrying out the deposition while reversing the conveyance direction of the substrate, the active material body having an arbitrary number n of layers can be continuously formed on the surface of the sheet-shaped substrate 4.

The foregoing has explained the operation of the thin film manufacturing apparatus 100 using an example in which the active material body made of the silicon oxide is formed. However, the deposition material used and the application of the deposited film are not limited to this. Moreover, in the foregoing explanation, the deposited film is formed by the reaction between the deposition material (silicon atoms) evaporated from the evaporation source 9 and the gas (oxygen gas) supplied from the nozzle portion 22. However, only the deposition material may grow on the surface of the substrate 4 without supplying the gas.

### Determination of Deposition Operation

Hereinafter, a method for determining signals detected by the dose detecting portions 50 and 51 will be explained in reference to the drawings.

FIG. 5 is a diagram showing sensor portions of the dose detecting portion.

Each of the dose detecting portions 50 and 51 includes a plurality of sensors that are the sensor portions 50a to 50j or 51a to 51j along the width of the substrate such that detection regions of the sensors overlap each other. The number of sensor portions is not limited to 50a to 50j or 51a to 51j but is suitably adjusted depending on the width of the substrate and the detection range of the sensor. Moreover, information obtained from each sensor portion is also managed as positional information in the substrate width direction.

The dose measured value information is recorded together with (n-th travel pass, substrate longitudinal positional information L, and substrate width positional information H). For example, in a case where a defect hole is detected in the first travel between the sensor portions 50a and 50b of the dose detecting portion 50 at a location where the substrate longitudinal distance is 300 meters, the measured values of the sensors 50a and 50b are recorded together with (1, 300, 50a) and (1, 300, 50b), respectively. Moreover, for example, in a case where the defect hole is detected in the second travel (reverse travel) at the sensor portion 51f of the dose detecting portion 51 at a location where the substrate longitudinal distance is 150 meters, the measured value of the sensor 51f is recorded together with (2, 150, 51f). With this, regarding a first measured value and a second measured value, the measured values of the defect location at the same substrate longitudinal positional information and the number of measured values at the same substrate longitudinal positional information can be managed. Therefore, the substrate conveyance and the film formation can be carried out while monitoring whether or not the diameter of the defect hole is expanding and growing. A relation between the first measured value and the second measured value may be as follows: After the first measured value is measured by the dose detecting portion 50, the deposition is carried out to form one-layer thin film, and the second measured value is then measured by the dose detecting portion 51; or after the first measured value is measured by the dose detecting portion 51, the conveyance direction of the substrate is reversed, and the second measured value is then measured by the dose detecting portion 51.

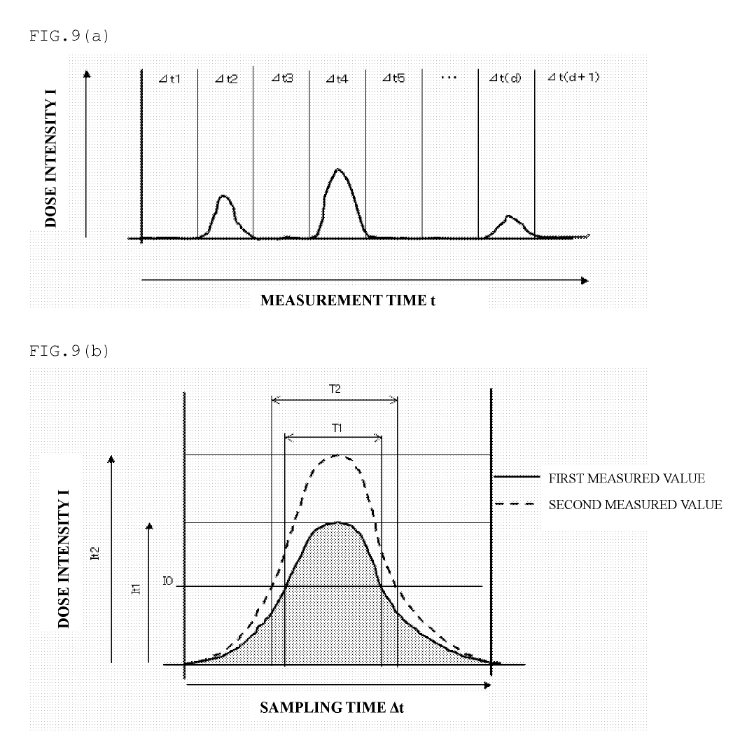

A method for processing detected data will be explained in reference to FIGS. 9(a) and 9(b). FIG. 9(a) is a diagram showing a measurement time t and a measurement dose intensity I. When the substrate conveyance speed measured by the length measuring system 13 is denoted by V, the substrate longitudinal positional information L is calculated by L=V×(Δt1+Δt2+Δt(d)) and is stored. FIG. 9(b) shows the measurement dose intensity I in a sampling time Δt(d). A time T1 in which the measurement dose intensity I exceeds a reference intensity I0 or an integrated value (intensity area S1) of the dose intensity in the sampling time Δt is stored in the controller 52 as the first measured value that is the measured value of the defect.

The data storage processing device 53 compares a predetermined set value with each of the measured values of the same substrate longitudinal positional information. For example, in FIG. 9(b), a case where Measurement Time T1 (or T2)−Predetermined Time T0>0 is determined as NG. Or, a case where Measured Area S1 (or S2)−Predetermined Intensity Area S0>0 is determined as NG.

Further, regarding the same substrate longitudinal positional information L, the first measured value (T1 or S1) and the second measured value (T2 or S2) are compared with each other. A case where Increased Time ΔT (=T2−Ti)>Predetermined Increased Time ΔTm is determined as NG. Or, a case where Increased Intensity Area ΔS (=S2−S1)>Predetermined Increased Intensity Area ΔSm is determined as NG.

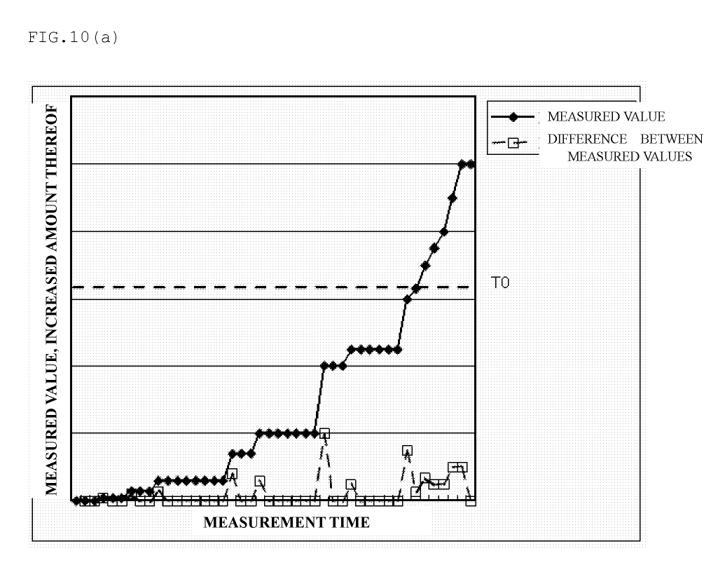

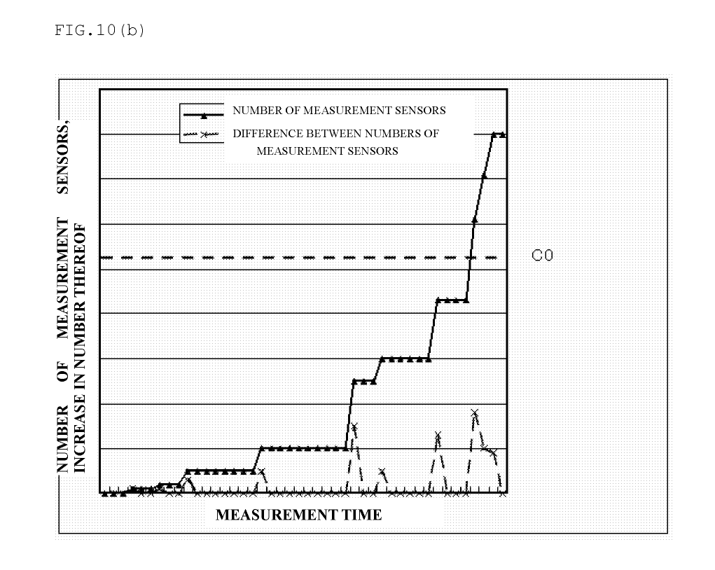

FIG. 10(a) is a measurement example showing the relation between the measurement time and the measured value and the relation between the measurement time and a measured value increased amount (difference of the measured value). The measured value increases as the measurement time passes.

Moreover, the data storage processing device 53 compares a predetermined set value with the number of substrate width positional information at the same substrate longitudinal positional information (the number of reacting measurement sensors). For example, a case where Number C1 (that is the number of sensors which has measured the defect, among a plurality of sensors arranged in the substrate width direction)−Number C0 of Setting Sensors>0 is determined as NG.

Further, regarding the same substrate longitudinal positional information L, the number C1 of sensors which have measured the defect in the first measurement and the number C2 of sensors which have measured the defect in the second measurement are compared with each other. A case where Number ΔC of Increased Sensors (=C2−C1)>Predetermined Number ΔCm of Increased Sensors is determined as NG.

FIG. 10(b) is a measurement example showing the relation between the measurement time and the number of measurement sensors and the relation between the measurement time and an increased number of measurement sensors (difference of the number of measurement sensors). The number of measurement sensors increase as the measurement time passes.

In a case where the determination is NG as above, the data storage processing device 53 outputs a signal to a substrate conveyance system to carry out an operation of preventing the substrate from tearing. As the operation of preventing the substrate from tearing, cancellation of the film formation, a reduction in amount of the film formation, a change in travel speed of the substrate, a reduction in tension applied to the substrate between the first roll and the second roll, or the like are suitably carried out.

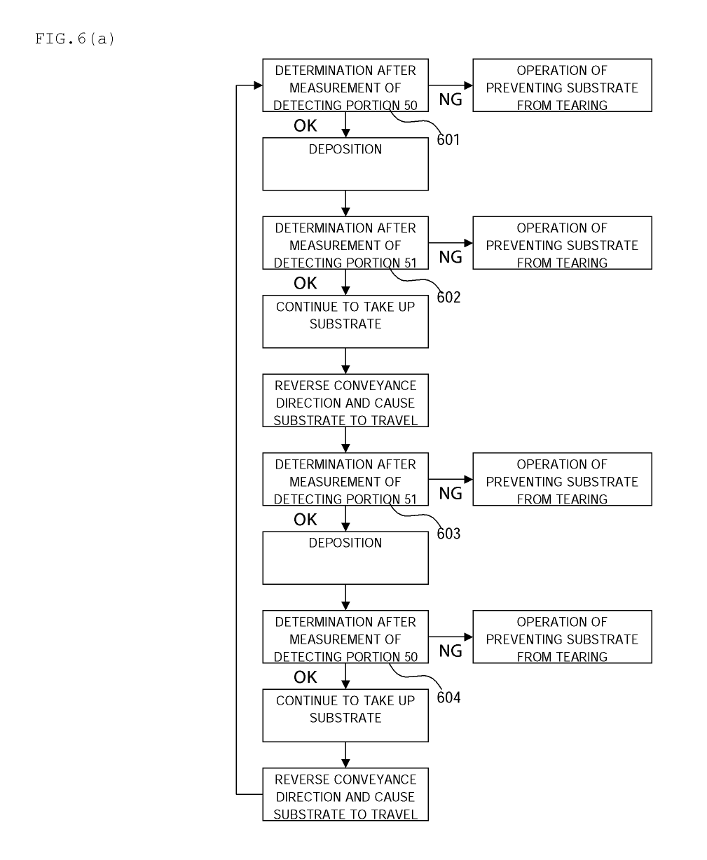

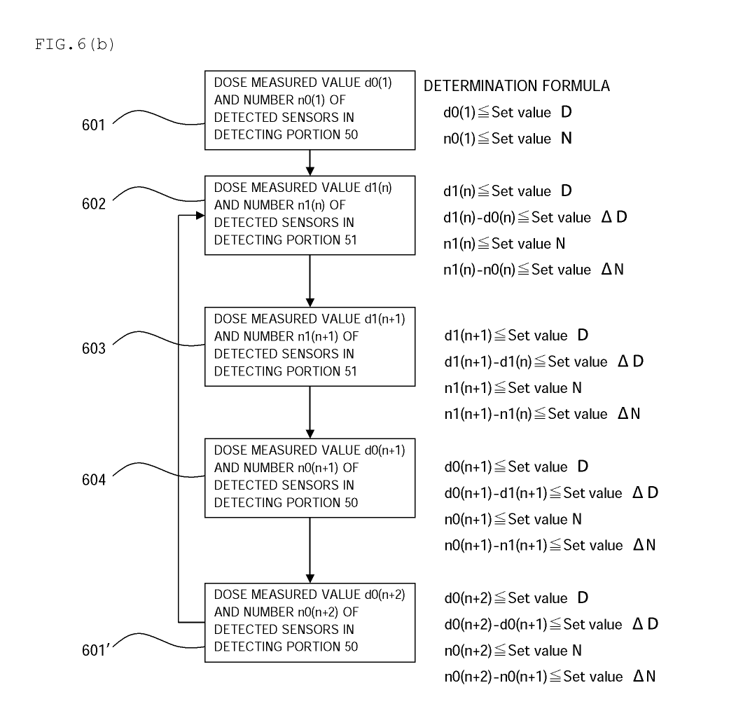

FIG. 6(a) is an operation flow chart of a deposition process based on the determination of the data storage processing device 53. FIG. 6(b) is a determination chart specifically showing the determination method of FIG. 6(a). The following explanation will be made based on FIGS. 6(a) and 6(b).

First, 601 shown in FIGS. 6(a) and 6(b) is the determination carried out before the substrate reaches the deposition region 60a and after the dose detecting portion 50 has carried out the measurement. In this determination, a case where the dose measured value (as described above, the dose measured value may be a measured value based on a time or a measured value based on an intensity area) detected in the sampling time Δt(d) is equal to or lower than a set value D is determined as OK, and the deposition operation continues. A case where the detected dose measured value exceeds the set value D is determined as NG. Moreover, a case where the number of sensors which have detected the defect in the sampling time Δt(d) among a plurality of sensors arranged in the substrate width direction on the dose detecting portion 50 is equal to or smaller than a set value N is determined as OK, and the deposition operation continues. A case where the number of sensors which have detected the defect exceeds the set value N is determined as NG.

### Travel Pass Is First Travel

Next, after the substrate has passed through the deposition regions 60a and 60b and been subjected to the deposition, in 602 shown in FIGS. 6(a) and 6(b), the dose detecting portion 51 carries out the measurement, and comparisons with the set values D and N are carried out in the same manner as in 601. Further, a difference calculation (defect expansion amount) between the dose measured values which have been respectively measured by the dose detecting portion 50 and the dose detecting portion 51 at the same substrate longitudinal position and the same substrate width position is carried out, and a comparison with a set value ΔD is carried out. A case where the obtained value exceeds the set value ΔD is determined as NG. Moreover, the difference calculation (increase in the number of sensors) between the number of sensors which have measured the defect in the dose detecting portion 50 and the number of sensors which have measured the defect in the dose detecting portion 51 at the same substrate longitudinal position and the same substrate width position is carried out, and a comparison with the set value ΔN is carried out. A case where the increase in the number of sensors exceeds the set value ΔN is determined as NG.

### Travel Pass Is Second Travel (Reverse Travel)

Next, the substrate conveyance direction is reversed. Before the substrate reaches the deposition region 60b, in 603 shown in FIGS. 6(a) and 6(b), the dose detecting portion 51 carries out the measurement, and comparisons with the set values D, N, ΔD, and ΔN are carried out. In the comparison with the set value ΔD, the difference calculation (defect expansion amount) between the dose measured values which have been measured by the dose detecting portion 51 at the same substrate longitudinal position and the same substrate width position before and after reversing the substrate conveyance direction is carried out. Moreover, in the comparison with the set value ΔN, the difference calculation (increase in the number of sensors) between the numbers of sensors which have measured the defect in the dose detecting portion 51 at the same substrate longitudinal position and the same substrate width position before and after reversing the substrate conveyance direction is carried out.

Further, after the substrate conveyance direction is reversed and the substrate passes through the deposition regions 60b and 60a from the second roll 8 to the first roll 3 and is subjected to the deposition, in 604 shown in FIGS. 6(a) and 6(b), the dose detecting portion 50 carries out the measurement again, and the comparisons with the set values D, N, ΔD, and ΔN are carried out. In the comparison with the set value ΔD, the difference calculation (defect expansion amount) between the dose measured values which have been respectively measured by the dose detecting portion 51 and the dose detecting portion 50 at the same substrate longitudinal position and the same substrate width position after reversing the substrate conveyance direction is carried out. Moreover, in the comparison with the set value ΔN, the difference calculation (increase in the number of sensors) between the number of sensors which have measured the defect in the dose detecting portion 51 after reversing the substrate conveyance direction and the number of sensors which have measured the defect in the dose detecting portion 50 after reversing the substrate conveyance direction at the same substrate longitudinal position and the same substrate width position is carried out.

### Travel Pass Is Third Travel (Normal Travel)

Next, after the substrate conveyance direction is further reversed, in 601 shown in FIG. 6(a) and 601′ shown in FIG. 6(b), the dose detecting portion 50 carries out the measurement again, and the comparisons with the set values D, N, ΔD, and ΔN are carried out. In the comparison with the set value ΔD, the difference calculation (defect expansion amount) between the dose measured values which have been measured at the same substrate longitudinal position and the same substrate width position by the dose detecting portion 50 before and after reversing the substrate conveyance direction is carried out. Moreover, in the comparison with the set value ΔN, the difference calculation (increase in the number of sensors) between the numbers of sensors which have measured the defect in the dose detecting portion 50 at the same substrate longitudinal position and the same substrate width position before and after reversing the substrate conveyance direction is carried out.

Further, after the substrate passes through the deposition region and is subjected to the deposition, 602 shown in FIGS. 6(a) and 6(b) is repeated. This step is the same as above.

After this, the operation of the second travel (reverse travel) and the operation of the third travel (normal travel) are repeated although the number of the travel pass changes. In a case where the determination is NG, the above-described operation of preventing the substrate from tearing is carried out.

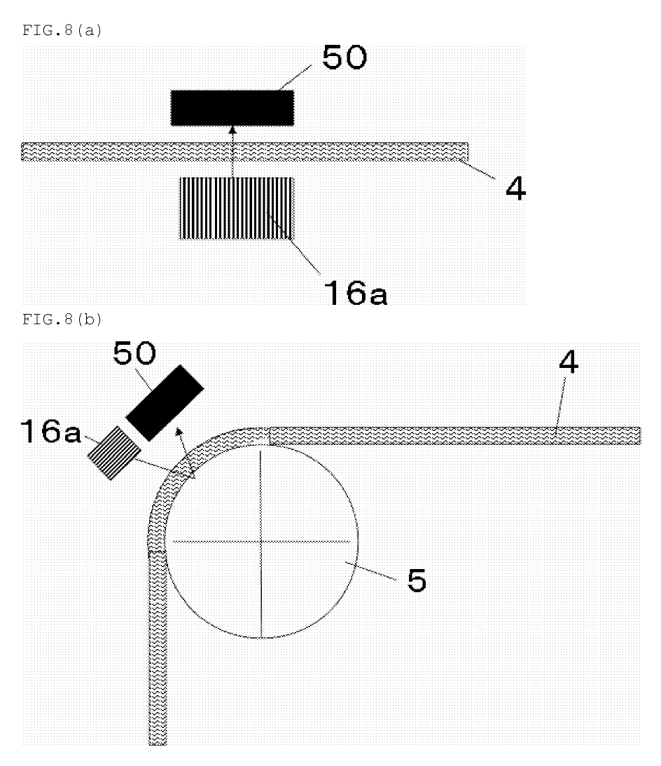

In Embodiment 1, as shown in FIG. 8(a), the source portion 16a or 16b and the dose detecting portion 50 or 51 are provided so as to sandwich the substrate 4. However, these portions may be provided as shown in FIG. 8(b). In FIG. 8(b), the source portion 16a and the dose detecting portion 50 are provided so as to face the same surface of the substrate 4. The roller 5 is provided so as to face the opposite surface of the substrate 4 and supports the opposite surface of the substrate 4. The surface of the substrate 4 having the opposite surface supported by the roller 5 is irradiated with the electromagnetic wave from the source portion 16a, and the electromagnetic wave having passed through the hole or crack of the substrate 4 and been reflected by the roller 5 is detected by the dose detecting portion 50. Since the substrate 4 is supported by the roller 5, there is no possibility that the substrate 4 is damaged. Here, in a case where the source portion 16a is the light source, by selecting the surface roughness of the substrate 4, the surface roughness of the roller 5, the material of the substrate 4, and the material of the roller 5 such that the reflectivity becomes different between the surface of the substrate 4 and the surface of the roller 5, the dose detecting portion 50 can detect the amount of light having passed through the hole or crack of the substrate 4 and been reflected by the roller. Moreover, in a case where the source portion 16a is the β-ray source, by selecting different materials between the roller 5 and the substrate 4, the dose detecting portion 50 can detect the defect on the substrate. This is because the amount of scattered β-ray is different between a case where the substrate 4 has no defect and a case where the substrate 4 has the defect. In a case where the source portion 16a is the X-ray source, by selecting different materials between the roller 5 and the substrate 4, the dose detecting portion 50 can detect the defect on the substrate. This is because in a case where the substrate 4 has no defect, characteristic X-ray (fluorescence X-ray) derived from the material of the roller 5 is attenuated by the substrate 4, and in a case where the substrate 4 has the defect, the dose intensity of the fluorescence X-ray is secured.

Instead of the roller 5, a metal plate having a flat surface may be provided on the opposite surface side of the substrate 4. The metal plate is provided such that the flat surface thereof does not contact the opposite surface of the substrate 4. The metal plate is provided so as to face the opposite surface of the substrate 4 not in a region where the substrate 4 is conveyed while being bent as in FIG. 8(b) but in a region where the substrate 4 is linearly conveyed. The surface of the substrate 4 having the opposite surface facing the flat surface of the metal plate is irradiated with the electromagnetic wave from the source portion 16a, and the dose detecting portion 50 detects the electromagnetic wave having passed through the hole or crack of the substrate 4 and been reflected by the flat surface of the metal plate. Since the electromagnetic wave is reflected by the flat surface and the reflection direction of the electromagnetic wave is easily predictable, the position of the dose detecting portion 50 is easily determined.

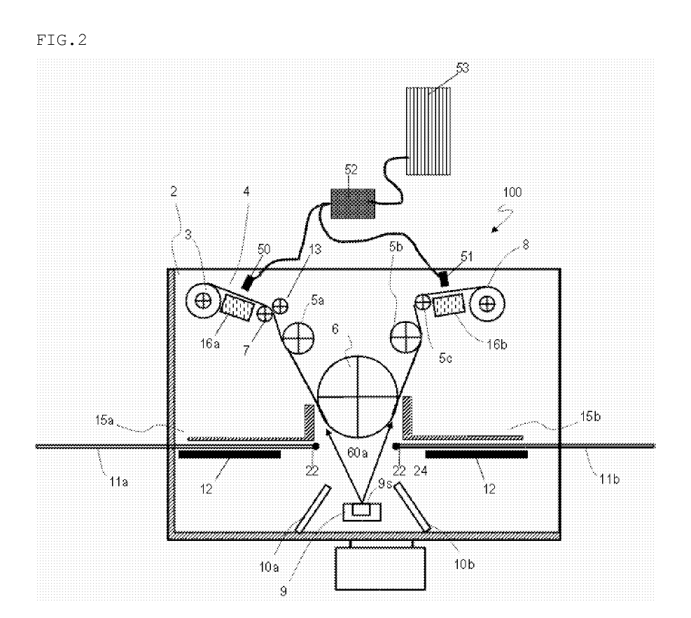

Moreover, Embodiment 1 has explained the operations using the device including two inclined film forming regions as shown in FIG. 1. However, even in the case of the device including one film forming region on a cylindrical shape as in FIG. 2, the substrate can be prevented from tearing by the same determinations of the operations of the device as above. Moreover, the number of film forming regions is not limited to two as in FIG. 1. The number of film forming regions may be three or more (four or eight, for example).

### Embodiment 2

Hereinafter, the thin film manufacturing apparatus of Embodiment 2 of the present invention will be explained in reference to the drawings. In the present embodiment, two V-shaped substrate passages (V-shaped passages) each similar to that of Embodiment 1 are provided, and four deposition regions (first to fourth deposition regions) 60a to 60d are formed. However, the conveying portion of the present embodiment is different from that of Embodiment 1 in that the substrate 4 having passed through the first and second deposition regions 60a and 60b is turned over and is guided to the third and fourth deposition regions 60c and 60d. In addition, the conveying portion of the present embodiment is different from that of Embodiment 1 in that a source portion 16c and a dose detecting portion 54 are further provided as an inspection device configured to measure the defect (pinhole or substrate crack) of the substrate 4 between the travel pass of a front surface deposition region and the travel pass of a rear surface deposition region to determine whether to execute the deposition and the substrate travel.

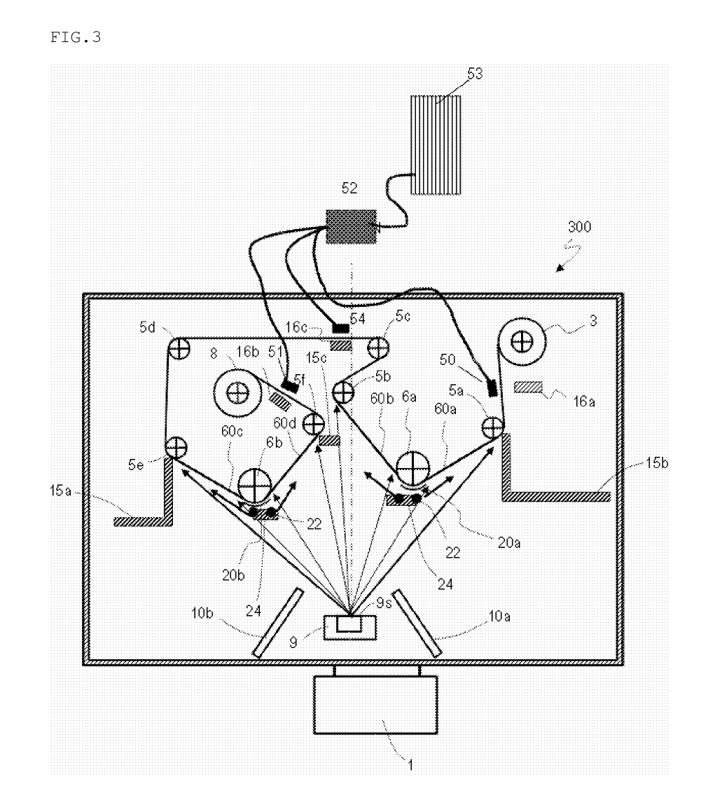

FIG. 3 is a cross-sectional view showing the thin film manufacturing apparatus of the present embodiment. For simplicity, the same reference signs are used for the same components as in the thin film manufacturing apparatus 100 shown in FIG. 1, and explanations thereof are omitted.

In a thin film manufacturing apparatus 300, the conveyance passage of the substrate 4 is defined by first and second rolls 3 and 8, feed rollers 5a to 5f, and first and second guide members 6a and 6b. The feed rollers 5c to 5e are provided between the second deposition region 60b and the third deposition region 60c on the conveyance passage of the substrate 4 so as to be located around the second roll 8 (inverted structure). With this configuration, a surface of the substrate 4 which surface faces the evaporation source 9s can be inverted. Therefore, when the substrate 4 passes through the first and second deposition regions 60a and 60b, the deposition can be carried out with respect to one surface (referred to as a “first surface”) of the substrate 4. When the substrate 4 passes through the third and fourth deposition regions 60c and 60d, the deposition can be carried out with respect to the other surface (referred to as a “second surface”) of the substrate 4. Therefore, in accordance with the thin film manufacturing apparatus 300, the deposited films can be continuously formed on both surfaces of the substrate 4 while maintaining the vacuum state in the chamber 2.

Moreover, in the present embodiment, the second deposition region 60b and the fourth deposition region 60d are formed to face each other, and the shielding plate 15c is provided between the deposition regions 60b and 60d so as to cover the feed rollers 5b and 5f The shielding plate 15c prevents the deposition material from being incident on the feed rollers 5b and 5f and controls the incidence angle at an upper end portion of each of the deposition regions 60b and 60d.

In the present embodiment, in the cross section perpendicular to the surface of the substrate 4 and including the conveyance direction of the substrate 4, the first guide member 6a and the second guide member 6b are respectively provided on both sides of a normal line N extending through the center of the evaporation surface 9s. Moreover, the conveying portion is provided with respect to the evaporation source 9 such that any one of the first to fourth deposition regions 60a to 60d (deposition region 60b in the example shown in the drawing) intersects with the normal line N extending through the center of the evaporation surface 9s. This is advantageous since the deposition can be carried out by maximally utilizing the region where the concentration of the deposition material is high, among the deposition possible regions. In the thin film manufacturing apparatus 300 shown, the second deposition region 60b and the fourth deposition region 60d are formed to face each other at substantially the center of the deposition possible region. However, in the present description, since the names of the deposition regions are determined along the conveyance passage, the other deposition regions may be provided to face each other at the center of the deposition possible region depending on the position of the conveying portion. In any case, the same effects as above can be obtained if one of two deposition regions provided to face each other at substantially the center of the deposition possible region is provided to intersect with the normal line N.

The source portion 16a and the dose detecting portion 50 are provided on the first roll 3 side, and the source portion 16b and the dose detecting portion 51 are provided on the second roll 8 side. Moreover, the source portion 16c and the dose detecting portion 54 are provided at a reverse passage extending between the deposition region 60b and the deposition region 60c. Moreover, each of the dose detecting portions 50, 51, and 54 is configured to include a plurality of sensors so as to be capable of performing detection in the entire width direction of the substrate 4 (FIG. 5).

With this configuration, it is possible to determine the increase of the defects of the substrate 4. This will be specifically explained below. Before the substrate 4 having been conveyed from the first roll 3 to the conveyance passage reaches the deposition region 60a, the electromagnetic wave from the source portion 16a passes through the defect of the substrate to be detected by the dose detecting portion 50. The measured value information of the detected electromagnetic wave is stored in the controller 52 together with the positional information of the substrate 4 and is compared with a predetermined set value by the data storage processing device 53.

Next, before the substrate 4 having passed through the deposition region 60a and the deposition region 60b and been subjected to the deposition reaches the deposition region 60c, the electromagnetic wave from the source portion 16c passes through the defect to be detected by the dose detecting portion 54. The measured value information of the detected electromagnetic wave is stored in the controller 52 together with the positional information of the substrate 4 and is compared with a predetermined set value by the data storage processing device 53. Further, the measured value information of the dose detecting portion 50 and the measured value information of the dose detecting portion 54, which have the same positional information as each other, are compared with each other.

Next, before the substrate 4 having passed through the deposition region 60c and the deposition region 60d and having the deposited first surface is taken up by the second roll 8, the electromagnetic wave from the source portion 16b passes through the defect to be detected by the dose detecting portion 51. The measured value information of the detected electromagnetic wave is stored in the controller 52 together with the positional information of the substrate 4 and is compared with a predetermined set value by the data storage processing device 53. Further, the measured value information of the dose detecting portion 54 and the measured value information of the dose detecting portion 51, which have the same positional information as each other, are compared with each other.

Next, the conveyance direction of the substrate 4 is reversed. Before the substrate 4 having been conveyed from the second roll 8 to the deposition region 60d and the deposition region 60c reaches the deposition region 60d, the electromagnetic wave from the source portion 16b passes through the defect to be detected by the dose detecting portion 51. The measured value information of the detected electromagnetic wave is stored in the controller 52 together with the positional information of the substrate 4 and is compared with a predetermined set value by the data storage processing device 53. Further, the measured value information of the dose detecting portion 51 before the substrate conveyance direction is reversed and the measured value information of the dose detecting portion 51 after the substrate conveyance direction is reversed, which have the same positional information as each other, are compared with each other.

Next, before the substrate 4 having passed through the deposition region 60d and the deposition region 60c and having the deposited second surface reaches the deposition region 60b, the electromagnetic wave from the source portion 16c passes through the defect to be detected by the dose detecting portion 54. The measured value information of the detected electromagnetic wave is stored in the controller 52 together with the positional information of the substrate 4 and is compared with a predetermined set value by the data storage processing device 53. Further, the measured value information of the dose detecting portion 51 and the measured value information of the dose detecting portion 54, which have the same positional information as each other, are compared with each other.

Next, before the substrate 4 having passed through the deposition region 60b and the deposition region 60a and been subjected to the deposition is taken up by the first roll 3, the electromagnetic wave from the source portion 16a passes through the defect to be detected by the dose detecting portion 50. The information of the detected measured value dose is stored in the controller 52 together with the positional information of the substrate 4 and is compared with a predetermined set value by the data storage processing device 53. Further, the measured value information of the dose detecting portion 54 and the measured value information of the dose detecting portion 50, which have the same positional information as each other, are compared with each other.

By repeating the same operations, it is possible to determine whether or not the defect on the substrate 4 is equal to or smaller than a set value, whether or not the defect is expanding by the conveyance, or whether or not there is the defect equal to or larger than the set value.

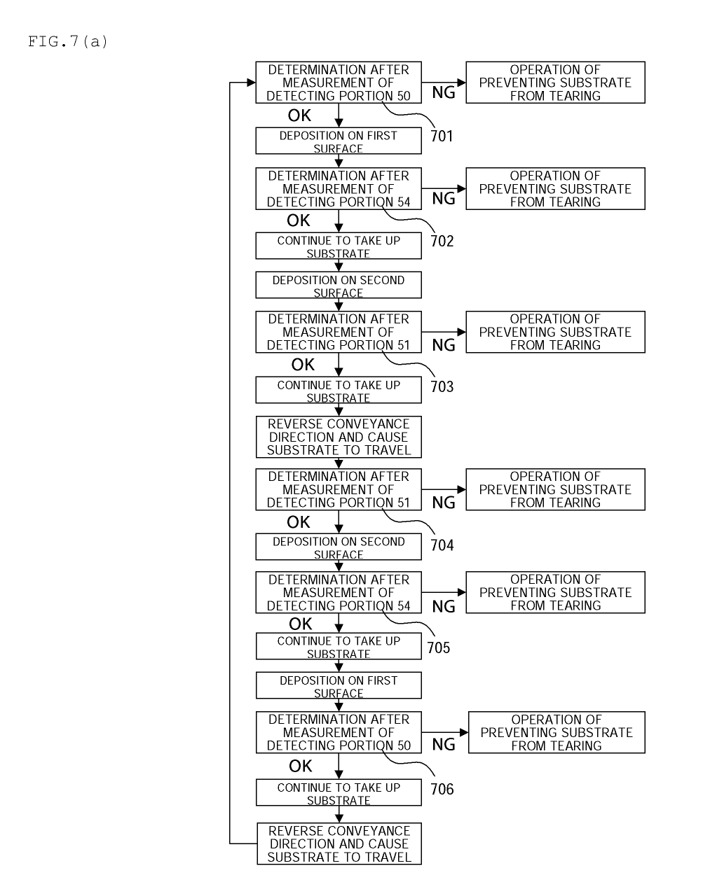

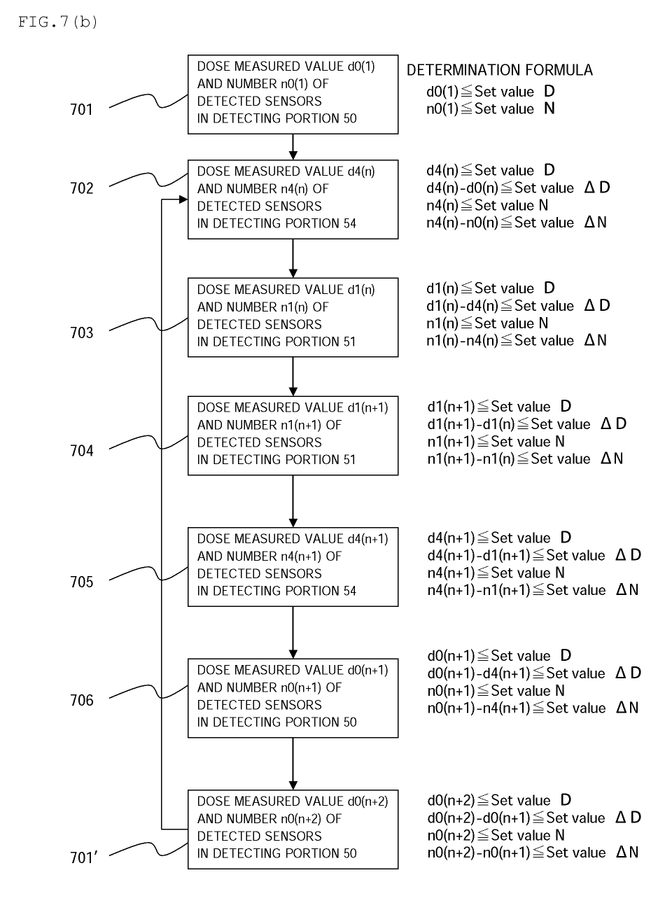

FIG. 7(a) is a process flow chart of a deposition process based on the determination of the data storage processing device 53 in Embodiment 2. FIG. 7(b) is a determination chart specifically showing the determination method of FIG. 7(a). A method for determining the signals detected by the dose detecting portions 50, 51, and 54 and a method for processing the detected data are the same as those in Embodiment 1.

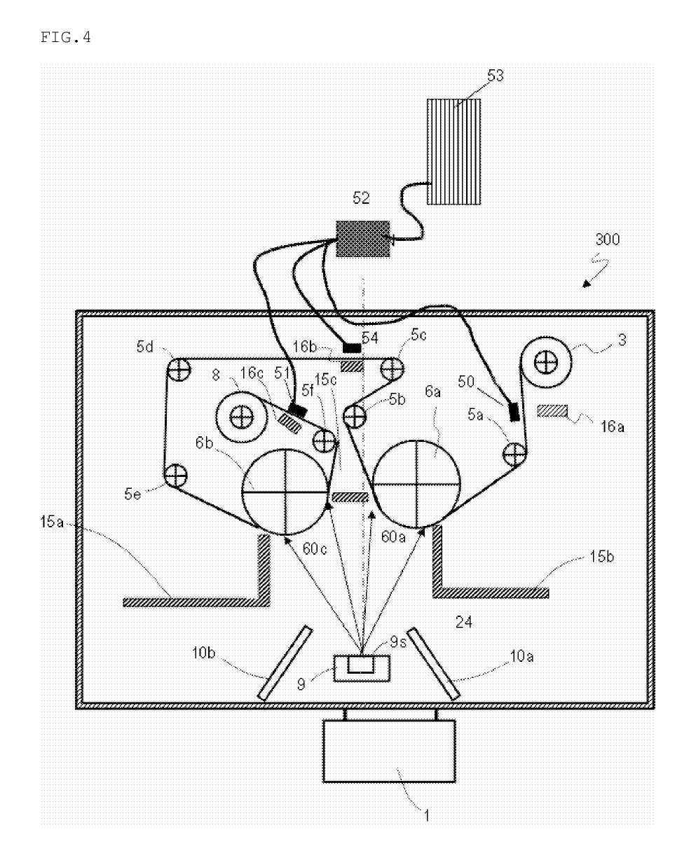

Moreover, Embodiment 2 has explained the operations using the device including four inclined film forming regions as shown in FIG. 3. However, even in the case of the device including two film forming regions on cylindrical shapes as in FIG. 4, the substrate can be prevented from tearing by the same determinations of the operations of the device as above. Moreover, the number of film forming regions is not limited to four as in FIG. 3. The number of film forming regions may be five or more (eight, for example).

In a case where the deposition material is silicon or tin, the deposited film formed on a current collector substrate by the thin film manufacturing method of the present invention can be utilized as a negative-electrode active material of a lithium ion secondary battery. The lithium ion secondary battery can be easily manufactured by using the deposited film together with a positive polar plate containing a generally-used positive-electrode active material, such as LiCoO₂, LiNiO₂, or LiMn₂O₄, a separator formed by a microporous film, and an electrolytic solution which is obtained by dissolving lithium hexafluorophosphate or the like in cyclic carbonates, such as ethylene carbonate or propylene carbonate, and has a generally known composition and lithium ion conductivity.

Moreover, the deposited film manufactured by the thin film manufacturing apparatus of the present invention can suppress the breakdown of an active material particle due to the expansion of the active material and is applicable to nonaqueous electrolyte secondary batteries of various shapes, such as a cylindrical shape, a flat shape, a coin shape, and a square shape, and the shape of the battery and a sealing structure are not especially limited.

### INDUSTRIAL APPLICABILITY

The thin film manufacturing method of the present invention may be used to manufacture electrochemical elements utilizing the deposited film, for example, to manufacture electrochemical devices, such as batteries, optical devices, such as photonic devices and optical circuit parts, and various device elements, such as sensors. The thin film manufacturing method of the present invention is useful to provide a battery polar plate for effectively bringing out the energy density of the active material which significantly expands due to charge and discharge.

### REFERENCE SIGNS LIST

1 exhaust pump

2 chamber

3, 8 pull-out roll or take-up roll

4 substrate

5a to 5f feed roller

6 guide member

7 driving roller

9 evaporation source

9s evaporation surface

10a, 10b shielding plate

11a, 11b gas introduction tube

12 shutter

13 length measuring system

15a to 15c shielding plate

16a to 16c source portion

20a, 20b shielding member

22 nozzle portion

24 nozzle portion shielding plate

50 first dose detecting portion

50a to 50j sensor portion

51 second dose detecting portion

51a to 51j sensor portion

52 controller

53 data storage processing device

54 third dose detecting portion

60a to 60d deposition region

100 thin film manufacturing apparatus

300 thin film manufacturing apparatus

1. A method for manufacturing a thin film, comprising:
a first film forming step of depositing a deposition material on a surface of a substrate in a deposition region to form the thin film while carrying out take-up travel of the substrate between a first roll and a second roll;
a first detecting step of irradiating a predetermined portion of the surface of the substrate with an electromagnetic wave or a particle beam at a location in front of the deposition region and/or a location behind the deposition region on a travel passage of the substrate between the first roll and the second roll and detecting the electromagnetic wave or particle beam, which has been transmitted through the substrate or reflected by the substrate;
a storing step of storing information regarding the electromagnetic wave or particle beam detected in the first detecting step and the predetermined portion;
a determining step of determining based on the electromagnetic wave or particle beam detected in the first detecting step whether or not a defect of the substrate at the predetermined portion is increasing; and
a preventing step of carrying out an operation of preventing the substrate from tearing, in accordance with a determination result of the determining step.

2. The method according to claim 1, wherein:
in the first detecting step, irradiation of the electromagnetic wave or particle beam is carried out at a plurality of locations on the travel passage of the substrate between the first roll and the second roll to irradiate the predetermined portion with the electromagnetic wave or the particle beam plural times, and a plurality of electromagnetic waves or particle beams which have been transmitted through the substrate or reflected by the substrate are detected; and
in the determining step, whether or not the defect of the substrate at the predetermined portion is increasing is determined by comparing the plurality of detected electromagnetic waves or particle beams with one another.

3. The method according to claim 2, wherein:
the plurality of locations includes the location in front of the deposition region and the location behind the deposition region; and
in the determining step, whether or not the defect of the substrate at the predetermined portion is increasing is determined by comparing the electromagnetic wave or particle beam detected at the location in front of the deposition region with the electromagnetic wave or particle beam detected at the location behind the deposition region.

4. The method according to claim 1, further comprising:
a reversing step of reversing a travel direction of the substrate after the first film forming step;
a second film forming step of further forming, after the reversing step, a thin film on the thin film formed in the first film forming step while carrying out the take-up travel of the substrate in a direction opposite to a take-up direction of the first film forming step; and
a second detecting step of irradiating, after the reversing step, the predetermined portion with the electromagnetic wave or the particle beam again at the location in front of the deposition region and/or the location behind the deposition region on the travel passage of the substrate between the first roll and the second roll and detecting the electromagnetic wave or particle beam which has been transmitted through the substrate or reflected by the substrate, wherein
in the determining step, whether or not the defect of the substrate at the predetermined portion is increasing is determined by comparing the electromagnetic wave or particle beam detected in the first detecting step with the electromagnetic wave or particle beam detected in the second detecting step.

5. The method according to claim 1, wherein the irradiation of the electromagnetic wave or particle beam is carried out with respect to a plurality of regions arranged in a width direction of the substrate.

6. The method according to claim 1, wherein the defect is a hole or a crack on the substrate.

7. The method according to claim 1, wherein each of the irradiating electromagnetic wave and the irradiating particle beam is ultraviolet, visible light, infrared light, X-ray, or β-ray.

8. The method according to claim 1, wherein each of the detected electromagnetic wave and the detected particle beam is the ultraviolet, the visible light, the infrared light, fluorescence X-ray, or scattered β-ray.

9. The method according to claim 1, wherein the irradiating electromagnetic wave is the ultraviolet, the visible light, or the infrared light, and the detected electromagnetic wave is the ultraviolet, visible light, or infrared light, which has been transmitted through the substrate.

10. The method according to claim 1, wherein each of the irradiating electromagnetic wave and the irradiating particle beam is the X-ray or the β-ray, and each of the detected electromagnetic wave and the detected particle beam is the fluorescence X-ray or scattered β-ray, which has been reflected by the substrate.

11. The method according to claim 1, wherein each of the irradiating electromagnetic wave and the irradiating particle beam is the X-ray or the β-ray, and each of the detected electromagnetic wave and the detected particle beam is the fluorescence X-ray or scattered β-ray, which has been reflected by a roll supporting the substrate or by a metal plate provided behind the substrate.

12. The method according to claim 1, wherein the operation of preventing the substrate from tearing is cancellation of film formation, a reduction in amount of the film formation, a change in travel speed of the substrate, or a reduction in tension applied to the substrate between the first roll and the second roll.
